(19) United States
(12) Patent Application Publication
(10) Pub. No.: US 2005/0044196 A1
(43) Pub. Date: Feb. 24, 2005

(54) Method of and system for host based configuration of network devices

(76) Inventors: Benjamin A. Pullen, Lexington, KY (US); Samuel L. Rhodus, Danville, KY (US); Kenneth R. Wilkerson, Lawrenceburg, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/638,211

(22) Filed: Aug. 8, 2003

(51) Int. Cl. G06F 15/173

(52) U.S. Cl. 709/223

(57) ABSTRACT

A method of configuring a peripheral device on a network. The method includes the acts of sending a request from a host across the network, receiving a response from the peripheral device and determining by the host whether to configure the peripheral device, without user intervention. The response includes a current configuration setting of the peripheral device.

### BACKGROUND OF THE INVENTION

The present invention relates to devices attached to a network and, more specifically, to a method of and system for configuring network devices.

Presently, many business environments, especially Small and Medium Business (“SMB”) environments, include various and numerous devices connected to a network. The network devices range from print servers, printers, scanners, routers, gateways, personal computers, servers, adapters, etc. When a device is first connected to the network, the device needs to be configured with certain settings or parameters to enable communication to other devices located on the network. Moreover, certain settings of the device may need to be periodically changed to accommodate additional devices, services or functions added to the network.

### SUMMARY OF THE INVENTION

The current adapter protocols are not capable of supporting host-based auto-configuration in an SMB environment. Existing systems require manual configuration prompted by a user or operator. Thus, every time an existing device needs to be reconfigured or a new device is added to the system, a user must manually enter the configuration settings into the system. A method of and system for host-based configuration of network devices without user intervention would alleviate time and resources currently dedicated to manually configuring network devices.

In one embodiment, the invention provides a method of configuring a peripheral device on a network having a host. The method includes the act of sending a request from the host across the network, the act of receiving a response from the peripheral device and the act of determining by the host whether to configure the peripheral device, without user intervention. The response from the peripheral device includes a current configuration setting of the peripheral device.

In another embodiment, the invention provides a process of configuring a unit on a network. The process includes the acts of sending a query packet over the network from a configuration utility, receiving a plurality of response packets sent from the units and sending a configuration packet from the configuration utility to a responding unit. The query asks for units to respond and each response identifies a unit that qualifies to be configured by the configuration utility.

In yet another embodiment, the invention provides a configuration utility for configuring units on a network. The configuration utility includes means for sending a query packet over the network and means for receiving a response packet from a responding unit. The response packet includes a current configuration setting of the responding unit. The configuration utility also includes means for determining whether to configure the responding unit based on the response packet and means for sending a configuration packet to the responding unit.

In a further embodiment, the invention provides a process of configuring a unit on a network. The method includes the acts of receiving a query packet over the network from a configuration utility and sending a response packet to a configuration utility in response to the query packet. The response packet includes a current configuration setting of the unit and indicates that the unit recognizes the query packet. The method also includes the acts of receiving a configuration packet over the network from a configuration utility, parsing the configuration packet for an updated configuration setting and changing the current configuration setting to match the updated configuration setting included in the configuration packet.

### BRIEF DESCRIPTION OF THE DRAWINGS

In the drawings:

FIG. 1 is a schematic diagram of a system embodying the invention.

FIG. 2 is a schematic diagram of an exemplary response from a device in the system shown in FIG. 1.

FIG. 3 is a schematic diagram of an exemplary configuration packet transmitted from a host to a device in the system shown in FIG. 1.

FIG. 4 is a schematic diagram of an exemplary acknowledge packet transmitted from a device to a host in the system shown in FIG. 1.

FIG. 5 is a schematic diagram of another system embodying the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings.

### DETAILED DESCRIPTION

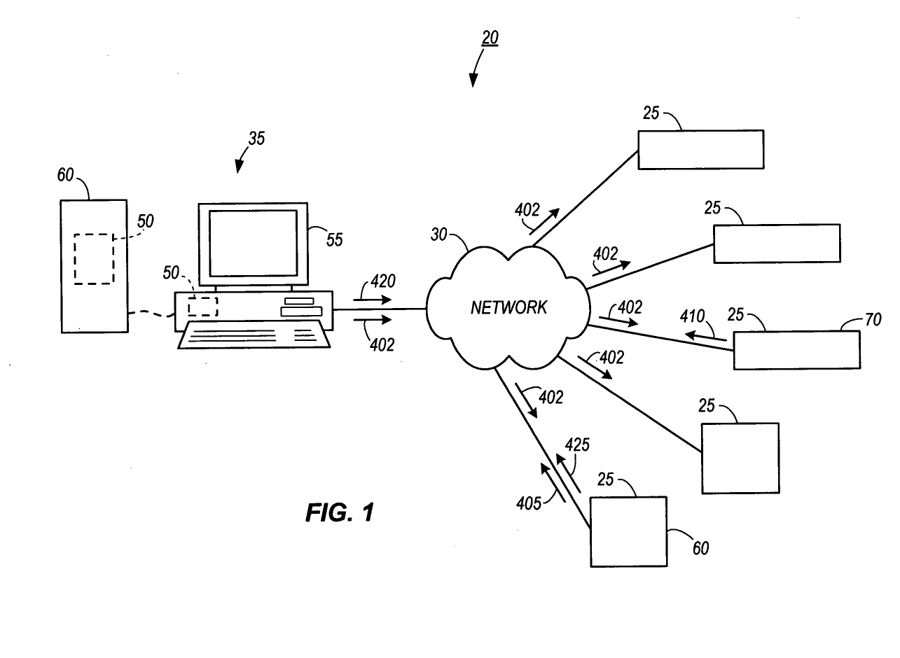

FIG. 1 illustrates an exemplary system 20 for automatically implementing host-based configuration of a network device 25. The system 20 includes a network 30, a host 35 connected to the network 30 and a network device 25 connected to the network 30. In the embodiment shown, the network device includes a plurality of network devices 25. In some embodiments, the plurality of network devices 25 are peripheral devices connected to the network 30, such as, for example, network adapters, routers, printers, scanners, bridges, print servers, personal computers (“PC”), workstations, all-in-one (“AIO”) devices, fax machines, multimedia devices, servers and/or are a variety of the above-mentioned peripheral devices and/or similar devices.

In the embodiment shown, the network 30 is a local area network (“LAN”), such as, for example, an Ethernet network or a token-ring network. In other embodiments, the network 30 is a wireless LAN (“WLAN”), a metropolitan area network (“MAN”), a wide area network (“WAN”) or another network.

The host 35 is a configuration utility application or configuration utility software module 50 (referred to simply as the configuration utility 50) installed on a workstation or PC 55 or installed on a remote device 60, but which runs on the host PC 55. For example, the remote device 60 can be an external memory card or device, a server, another PC, an adapter, etc. In other embodiments, the host 35 is the configuration utility 50 installed and run on a server, an adapter or another peripheral device connected to the network 30. In further embodiments, the host 35 is the configuration utility 50 running on a server, computer or processor located on another network.

When the configuration utility 50 is installed on the host device, such as the PC 55 or server 60 for example, the configuration utility 50 recognizes or reads the network settings and the configuration settings of the host device 35 (e.g., the PC 55), such as, for example, the IP address for the host device 35, the network address, the subnet mask address, the host number, etc. In one embodiment, the configuration utility 50 recognizes the particular network settings and stores the settings in a new file. In other embodiments, the configuration utility 50 recognizes the particular network settings and stores the location of the settings (i.e., location of the settings as stored on the host device 35) rather than the actual settings.

To begin the host-based configuration process, the configuration utility 50 sends a query or request across the network 30. In some embodiments, the request is a broadcast (i.e., a message sent to all nodes, units and/or devices on a network), a multicast (i.e., a message sent to some of the nodes, units and/or devices on a network) or a unicast (i.e., a message sent to one node, unit or device on a network). In one embodiment, the request is a discovery request for the configuration utility 50 to determine what devices are connected to the network 30. In other embodiments, the request is a Domain Name Service Query packet. The discovery request is transmitted (via broadcast, multicast or unicast) using User Datagram Protocol (“UDP”). For example, the discovery request is transmitted via a broadcast to a dedicated UDP port, such as UDP port 5353. In the embodiment shown, the discovery request is transmitted as a broadcast to the plurality of devices 25 connected to the network 30.

Upon reception of the discovery request, the device 25 reads the discovery request, generates an appropriate response and transmits its response to the host device 35 and the configuration utility 50. In one embodiment, the configuration utility 50 transmits the discovery request, via the broadcast, and asks for any network device 25 that reads the request to transmit a service announcement as the appropriate response. In another embodiment, the configuration utility 50 transmits the discovery request, via the broadcast, and asks for any network device 25 that reads the request to transmit a service announcement as well as the current device-specific settings and the current network settings of the device 25.

In some instances, not all of the network devices included in the plurality of devices 25 respond to the discovery request. For example, some network devices, such as adapter 60 and print server 70 may lack the capability or software to read and/or recognize the discovery request, the adapter 60 and the print server 70 may have lost power or the discovery request was a multicast and not directed or addressed to the adapter 60 and print server 70. In other instances, all of the network devices 25 respond to the discovery request, and in still other instances, none of the network devices 25 respond.

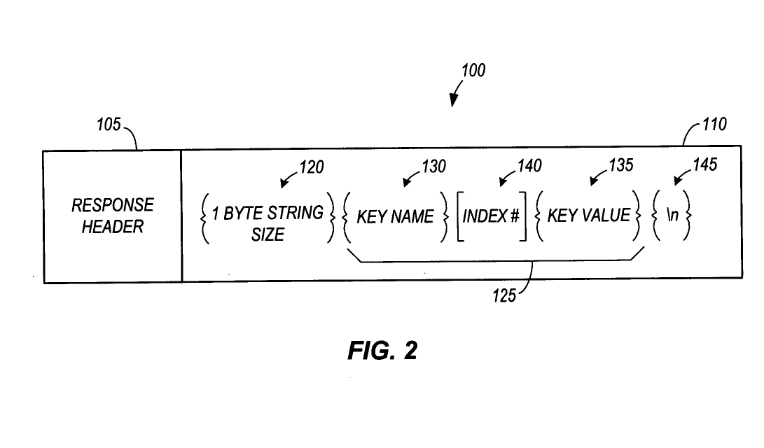

An exemplary response 100 that is transmitted by a responding device 25 is illustrated in FIG. 2. The response 100 includes a response header 105 and a response body 110. In some embodiments, the response header 105 is a service announcement, and the response body 110 includes the binary data payload. In one embodiment, the binary data payload is a text file, such as an ASCII text file. In another embodiment, the binary data payload is encrypted.

In the embodiment shown, the response body 110 includes a current network setting of the responding device 25. In another embodiment, the response body 110 includes a current device-specific setting of the responding device 25, and in yet another embodiment, the response body 110 includes both a current device-specific setting and a current network setting of the responding device 25.

As shown in FIG. 2, the response body 100 includes a preface string 120 and a body string 125 that follows the preface string 120. The preface string 120 defines the size of the following body string 125. In some embodiments, multiple body strings 125 follow the preface string 120, and the preface string 120 defines the combined size of all the following strings 125. In the embodiment shown, the preface string 120 is one byte and information (e.g., size of the following string 125) is stored as a hex number. One example of a response body is shown below as Example 1.

### EXAMPLE 1

### 0×14ipname “AdapterName”(\n)

In Example 1, the preface string 120 is “0×14”. Another example of a response body is shown below as Example 2.

### EXAMPLE 2

### 0×29domainsearchorder3 “pad.prtdev.lexmark.com”(\n)

In Example 2, the preface string 120 is “0×29”.

As shown in FIG. 2, the following body string 125 includes a key name substring 130, a key value substring 135 and an index substring 140. The key name substring 130 identifies the variable or the type of information being sent in the response body 110. In the embodiment shown, the key name substring 125 identifies a current network setting or parameter of the responding network device 25. In the first example listed above, the network setting being identified is “ipname” or the IP name/address of the responding device 25. In some embodiments, the network settings include, for example, TCP/IP settings or parameters, IP address, adapter type, locally administered address (“LAA”), universal administered address (“UAA”), media access control (“MAC”) address, device type(s) attached, method of current parameter configuration (e.g., Automatic Private IP Addressing (“APIPA”), Dynamic Host Configuration Protocol (“DHCP”), statically assigned, etc.), adapter name, password enabled, original equipment manufacture (“OEM”) byte, etc. In another embodiment, the key name substring 130 identifies a current device-specific setting, such as, for example, a default scanning resolution for a scanner.

The key value substring 135 identifies the value of the information being sent in the response body 110. In the embodiment shown, the key value substring 135 identifies the value of the current network setting identified in the key name substring 130. In Example 1 (listed above), the key name substring 130 identifies “ipname” as the network setting, and the key value substring 135 identifies “AdapterName” as the value of the IP name network setting.

In some embodiments, the key name substring 130 includes more than one value and thus, requires more than one key value substring 135. In these embodiments, the index substring 140 is included. The index substring 140 is an optional substring that identifies the different key value substrings 135. In Example 2 (listed above), the key value substring 135 “pad.prtdev.lexmark.com” is one value of at least three options or values for the key name substring 130 of “domainsearchorder” as indicated by the index substring 140 of “3”. In other embodiments, the index can also represent an order for the key value substrings 135. For example, the “3” in the index substring 140 may indicate that the following or corresponding key value substring (i.e., “pad.prtdev.lexmark.com”) is the third value for the key name substring 130 of “domainsearchorder”.

In the embodiment shown and in the examples discussed above, the response body 110 is an ASCII text format. Therefore, the body 110 may be extended to any length containing any number of supported network settings. In this embodiment, each length, variable and variable value (e.g., the preface substring 120 and a single following substring 125) is succeeded by a new line character 145. In the embodiment shown, the new line character 145 is “(\n)”. For example, the response 100 includes the response header 105 succeeded by the response body 110, which includes the response body example 150 followed by the response body example 155. In other embodiments, the response body 110 includes binary payload data which is encrypted.

Referring again to FIG. 1, each device 25 that recognizes the discovery request transmits its response 100 (see FIG. 2) with its the current network settings to the configuration utility 50. In one embodiment, the response 100 is transmitted via a Transmission Control Protocol (“TCP”) unicast to the host device 35 and the configuration utility 50.

Upon reception of a response 100 from a responding device 25, the configuration utility 50 reads the response 100 and automatically compares the binary data payload or information included in the response body 110 to existing or discovered information. In one embodiment, the information in the response body 110 includes the current network setting(s) and/or the current device-specific setting(s) of the responding device 25, and the existing or discovered information includes the network setting(s) and/or the device-specific setting(s) recognized by the configuration utility 50.

For example, existing or discovered network settings that the configuration utility 50 recognizes can include one or more network settings which correspond to one of more network settings of host device 35 or one or more settings of the network (such as network 30) by which the responding device 25 was discovered on. Furthermore, as an example, the existing or discovered device-specific settings that the configuration utility recognizes can include default device-specific settings that the configuration utility 50 downloaded from another device or settings required by another network device or application. After comparing the information, such as the network setting(s), the configuration utility 50 determines whether to automatically reconfigure the responding device 25, without user intervention. In one embodiment, the configuration utility 50 determines whether to reconfigure the responding device 25 based on whether the received network setting(s) match the discovered network setting(s). In another embodiment, the configuration utility 50 determines whether to reconfigure the responding device 25 based on whether the received device-specific setting(s) match the existing device-specific setting(s).

If the configuration utility 50 determines to reconfigure the responding device 25, such as, for example, automatically reconfiguring the network setting(s) to coincide with the existing or discovered network setting(s), the configuration utility 50 generates and transmits a configuration packet. In one embodiment, the configuration utility 50 disables any similar configuration applications running on the device 25, such as, for example, Auto private IP assignment, Rendezvous, Dynamic Host Configuration Protocol (“DHCP”), etc., prior to transmitting the configuration packet. In another embodiment, any similar configuration applications running on the network 30 are disabled at the responding device end by a command or setting in the configuration packet. In some embodiments, the configuration utility 50 transmits the configuration packet via a UDP unicast. In other embodiment, the configuration utility 50 transmits the configuration packet via a UDP multicast or broadcast.

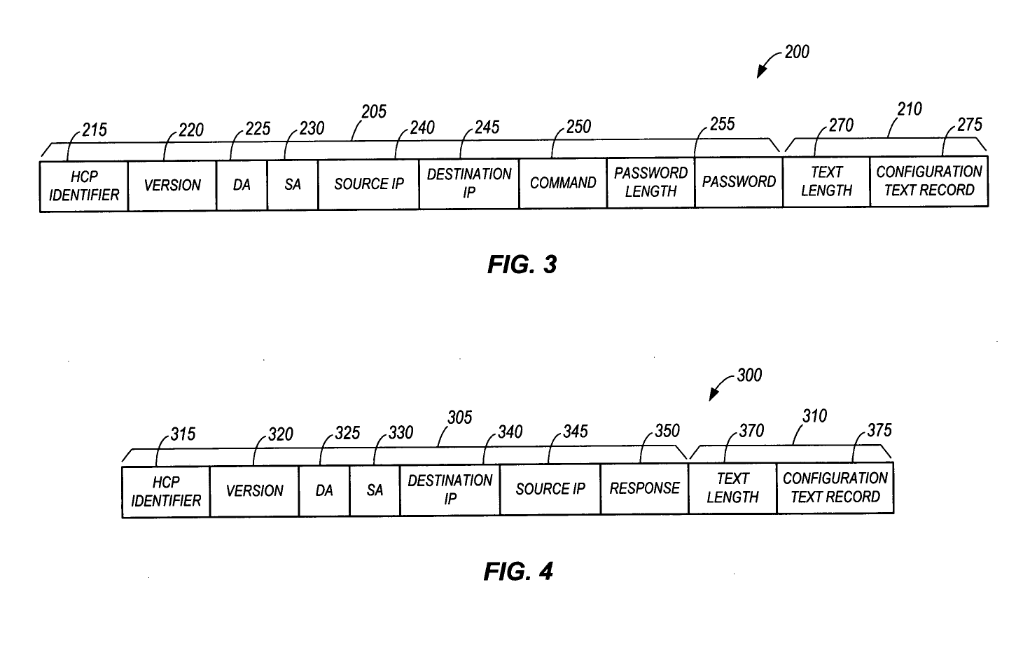

An exemplary configuration packet 200 is illustrated in FIG. 3. The configuration packet 200 utilizes a proprietary protocol to communicate with the responding device 25. The configuration packet 200 includes a packet header 205 followed by a payload 210. In one embodiment, the packet header 205 is a proprietary protocol packet header and the payload 210 is a text record having a tag-file format. The packet header 205 includes the destination or receiver information as well as the source or sender information. The payload 210 includes the information needed to reconfigure the responding device. In some embodiments, the information needed to reconfigure the responding device 25 is the existing or discovered network settings.

In the embodiment shown, the packet header 205 includes an identifier subpacket 215, a version subpacket 220, a destination subpacket 225, a source subpacket 230, a source IP subpacket 240 and a destination IP subpacket 245. The identifier subpacket 215 includes the configuration utility identifier, and the version subpacket 220 includes the current version number of configuration utility 50.

The destination subpacket 225 includes the address of the responding device 25. In one embodiment, the destination subpacket 225 utilizes the MAC address or the UAA address of the responding device 25 as the destination address. The source subpacket 230 includes the address of the host device 35 (i.e., the PC 55 or the remote device 60). In one embodiment, the source subpacket 230 utilizes the MAC address or the UAA address of the host device 35. In some embodiments, the responding device 25 will use the information included in the source subpacket 230 to direct the following response.

The source IP subpacket 240 includes the IP address of the host device 35 (i.e., the PC 55 or the remote device 60). In some embodiments, the source IP subpacket 240 may be ignored by the responding device 25 and may be optional in the configuration packet 200. The destination IP subpacket 245 includes the current IP address of the responding device 25 as advertised in the response 100.

In the embodiment shown, the packet header 205 also includes a command and password information. In the embodiment shown, the packet header 205 includes a command subpacket 250 and a password subpacket 255. The command subpacket 250 includes a command which the configuration utility 50 instructs the responding device 25 to perform. In one embodiment, the command subpacket 250 includes the command to configure certain settings identified in the payload 210. The password subpacket 255 includes the length of the password as well as the encrypted password. In some embodiments, the password is disabled by the configuration utility 50 and causes the length of the password to be zero. In the illustrated embodiment, the subpackets 215, 220, 225, 230, 240, 245 and 250 each have a set length.

The payload 210 includes a length subpacket 270 and a data subpacket 275. The length subpacket 270 indicates the length of the following data subpacket 275. The data subpacket 275 includes the information required for the responding device 25 to perform the command transmitted in the command subpacket 250. In the embodiment shown, the data subpacket 275 includes the existing or discovered network settings which the responding device 25 is commanded to reconfigure. In one embodiment, the data subpacket 275 includes a text file. The text file includes a series of delimited text strings which include the information, such as the configuration settings (e.g., the device-specific settings or the network settings). In another embodiment, the data subpacket 275 includes encrypted data.

Upon reception of the configuration packet 200, the responding device 25 will read the packet 200 and perform the command, such as configuring certain network or configuration settings. When the command is completed or an error occurs, the responding device 25 issues an acknowledge packet and transmits the acknowledge packet to the host device 35 and the configuration utility 50. In one embodiment, the responding device 25 transmits the acknowledge packet via a TCP unicast. In another embodiment, the responding device 25 transmits the acknowledge packet via a UDP unicast. In further embodiments, the responding device 25 transmits the acknowledge packet via a multicast or a broadcast.

An exemplary acknowledge packet 300 is illustrated in FIG. 4. The acknowledge packet 300 utilizes the same proprietary protocol to communicate with the configuration utility 50. The acknowledge packet 300 includes a packet header 305 and a payload 310, similar to the configuration packet 200.

In the embodiment shown, the packet header 305 includes an identifier subpacket 315, a version subpacket 320, a destination subpacket 325, a source subpacket 330, a destination IP subpacket 340, a source IP subpacket 345 and a response subpacket 350. The identifier subpacket 315 and the version subpacket 320 are the same as the identifier subpacket 215 and version subpacket 220 of the configuration packet 200, respectfully.

The destination subpacket 325 includes the address of the host device 35 (i.e., the PC 55 or the remote device 60). In one embodiment, the destination subpacket 225 includes the MAC address or the UAA address of the host device 35 as advertised in the source subpacket 230 of the configuration packet 200. The source subpacket 330 includes the address of the responding device 25. In one embodiment, the source subpacket 230 utilizes the MAC address or the UAA address of the responding device 25.

The destination IP subpacket 340 includes the IP address of the host device 35 (i.e., the PC 55 or the remote device 60). In some embodiments, the destination IP subpacket 340 may be ignored and may be optional in the acknowledge packet 300. The source IP subpacket 345 includes the IP address of the responding device 25 as advertised in the response 100.

The response subpacket 350 includes information regarding the performed command included in the command subpacket 250 of the configuration packet 200. In the embodiment shown, the response subpacket 350 indicates the status of the command, for example, either successful, password not verified or an error occurred performing the command. In one embodiment, the command is to reconfigure network settings, and the response indicates the status of performing the reconfiguration.

The payload 310 includes a length subpacket 370 and a data subpacket 375. The length subpacket 370 indicates the length of the following data subpacket 375. The data subpacket 375 includes the information regarding the command, such as a detailed explanation or code describing an error or describing the results of the performed command. In one embodiment, the command is to reconfigure network settings of the responding device 25, and the data subpacket 375 indicates the results of the command, such as the new network settings as stored in the responding device 25, errors that occurred during reconfiguration, etc.

An example of the operation of the system 20 is given below in reference to FIG. 1. In this example, the configuration utility 50 transmits the discovery request 402 via a broadcast across network 30 to the plurality of devices 25. Adapter 60 and print server 70 are the only network devices 25 in network 30 that recognize the discovery request 402 transmitted by the configuration utility 50. The adapter 60 and the print server 70 prepare the appropriate response 405 and 410, respectively. In this example, response 405 and response 410 are similar to the response 100 shown in FIG. 2 and include the current network settings for each of the devices. The adapter 60 and print server 70 transmit the responses 405 and 410 via a TCP unicast to the host device 35 (i.e., the PC 55 or remote device 60 including the configuration utility 50).

Upon receipt of the response 405 from the adapter 60 and the response 410 from the print server 70, the configuration utility 50 reads the responses 405 and 410. The configuration utility 50 also compares the received network settings (i.e., network settings included in the response 405 or 410) with existing or discovered network settings and compares received device-specific settings (i.e., device-specific settings included in the response 405 or 410) with existing or discovered device-specific settings. After comparing the network and device-specific settings, the configuration utility 50 determines whether to reconfigure any of the settings of the adapter 60 and whether to configure any of the settings of the print server 70, without user intervention.

In this example, the received network settings of the print server 70 match the existing or discovered network settings recognized by the configuration utility 50. In one instance, a device-specific setting (such as print resolution or default printer) does not match the discovered device-specific setting recognized by the configuration utility 50. Since the received network settings of the print server 70 are matched (i.e., do not necessitate reconfiguration), the configuration utility 50 can send the configuration packet (for reconfiguring the device-specific setting) via a TCP transmission, rather than via a UDP transmission.

In another instance, all of the received settings (i.e., the received network settings and/or the received device-specific settings) of the print server 70 match the existing or discovered settings recognized by the configuration utility 50. Therefore, the configuration utility 50 determines not to reconfigure the settings of the print server 70 and does not send any message to the print server 70.

In a further instance, the received network settings of the adapter 60 do not match the discovered network settings recognized by the configuration utility 50. Therefore, the configuration utility 50 determines to reconfigure the network settings of the adapter 60. The configuration utility 50 prepares a configuration packet 420, similar to the configuration packet 300 shown in FIG. 3, addresses the packet 420 to the adapter's MAC address (advertised in the response 405) and includes a new IP address as the updated configuration setting. The configuration utility 50 transmits the configuration packet 420 as either a UDP unicast, a UDP multicast or a UDP broadcast.

The adapter 60 receives the configuration packet 420 and parses the message or packet 420 for the command stored, such as the command to reconfigure. The adapter 60 then parses the payload 210 of the packet 420 for the information, such as the configuration settings, stored in a text record or file. In this example, the adapter 60 updates the appropriate network settings with the information included in the text file and generates the acknowledge packet 425. In this example, an error occurred during reconfiguration. Thus, the acknowledge packet 425 indicates the error and provides information in the text record or file regarding the error, such as when the error occurred.

The configuration utility 50 receives the acknowledge packet 425 and parses the response subpacket 350 and data subpacket 375. The configuration utility 50 generates a second configuration packet, which may be the same as the first configuration packet 420 or include a different command or different network setting values. In this example, the process of reconfiguring the adapter 60 may continue until the adapter 60 has successfully reconfigured the network settings as indicated by the configuration utility 50 or until a predefined number of attempts (e.g., the number of configuration packets 200 that have been transmitted to a given device or the number of error responses include in the acknowledge packets 300) have occurred.

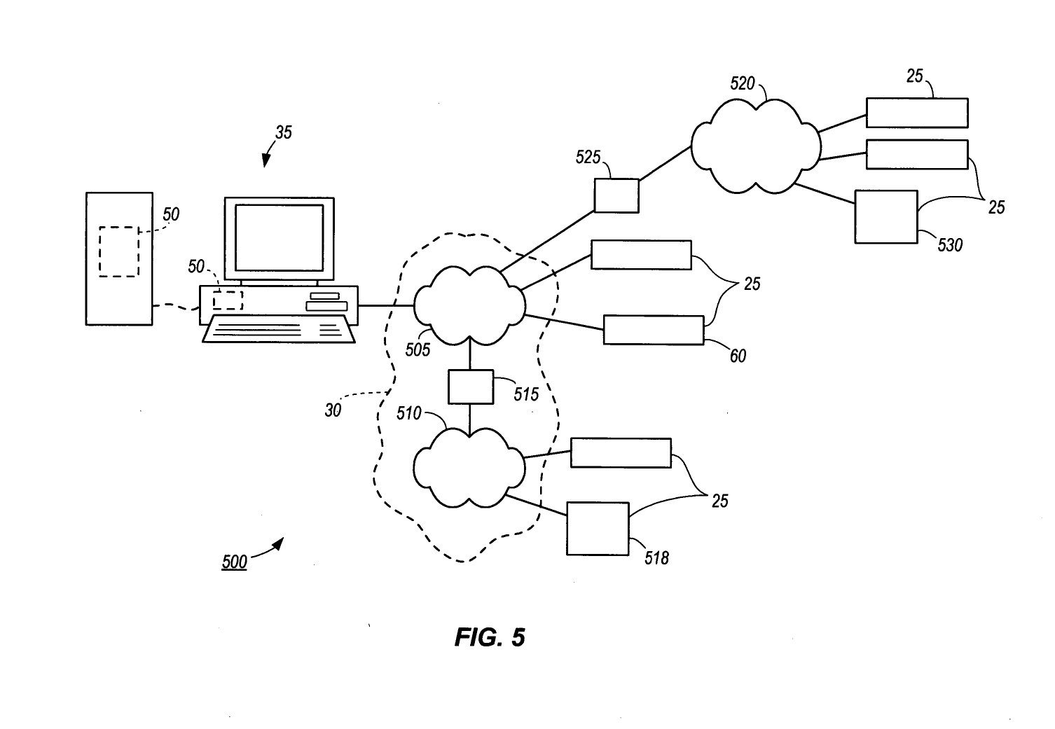

As shown in FIG. 5, the configuration utility 50 can also discover and reconfigure a device 25 located on a different subnetwork or on a different network. In the illustrated embodiment, the system 500 includes the network 30 having two different subnetworks and a second network 520 that differs from network 30. Subnetwork 505 and subnetwork 510 are subnetworks of network 30 and are connected by a router 515. The router 515 routes the request, the response 100, the configuration packet 200 and the acknowledge packet 300 between the host device 35 (located on subnetwork 505) and a device, such as printer 518 (located on subnetwork 510). In the illustrated embodiment, the network 30 is connected to a different network 520 via a bridge 525. The bridge 525 converts and routes the request, the response 100, the configuration packet 200 and the acknowledge packet 300 between the host device 35 (located on network 30) and a device, such as adapter 530 (located on network 520).

Thus, the invention provides, among other things, a method of and system for host-based autoconfiguration of network units or devices. Various features and advantages of the invention are set forth in the following claims.

1. A method of configuring a peripheral device on a network, the method comprising the acts of:
sending a request from a host across the network;
receiving a response from the peripheral device, the response including a current configuration setting of the peripheral device; and
determining by the host whether to configure the peripheral device, without user intervention.

2. A method as set forth in claim 1 and further comprising the act of:
sending a configuration message from the host to the peripheral device, the configuration message including an updated configuration setting for the peripheral device, the updated configuration setting generated and sent by the host without user intervention.

3. A method as set forth in claim 2 and wherein the configuration message includes a data payload.

4. A method as set forth in claim 1 and wherein the act of sending a request from a host across the network includes the act of sending a request via a broadcast from a host device across the network.

5. A method as set forth in claim 1 and wherein the act of sending a request from a host across the network includes the act of sending a request via a multicast from a host device across the network.

6. A method as set forth in claim 1 and wherein the act of sending a request from a host across the network includes the act of sending a request via a unicast from a host device across the network.

7. A method as set forth in claim 1 and wherein the peripheral device is a printer.

8. A method as set forth in claim 1 and wherein the peripheral device is a print server.

9. A method as set forth in claim 1 and wherein the peripheral device is an adapter.

10. A method as set forth in claim 1 and wherein the host is a configuration utility software installed on a device.

11. A method as set forth in claim 1 and wherein the configuration setting includes one of:
a network setting and a device-specific setting.

12. A method of configuring a unit on a network, the method comprising the acts of:
sending a query packet over the network from a configuration utility, the query asking for units to respond;
receiving a plurality of response packets sent from the units, each response packet identifying a unit to be configured by the configuration utility; and
sending a configuration packet from the configuration utility to a responding unit.

13. The method as set forth in claim 12, wherein the act of sending a query packet from the configuration utility includes sending the query packet via a broadcast to all nodes on the network.

14. The method as set forth in claim 12, wherein the act of sending a query packet from the configuration utility includes sending the query packet via a multicast to multiple nodes on the network.

15. The method as set forth in claim 14, wherein the query packet is a Domain Name Service Query packet.

16. The method as set forth in claim 15, wherein the response packets are Domain Name Service Announcement packets.

17. The method as set forth in claim 16, wherein each response packet also contains the current configuration settings of the unit sending the response packet.

18. The method as set forth in claim 17, wherein the current configuration settings in the response packet are communicated by a series of delimited text strings.

19. The method as set forth in claim 17, wherein the current configuration settings include at least one of a network setting and a device-specific setting.

20. The method as set forth in claim 19, wherein the responding unit is a print server.

21. The method as set forth in claim 20, wherein the current configuration settings include information about a device attached to the print server.

22. A software configuration utility stored on computer readable medium and for configuring units on a network, the software configuration utility comprising:
program code for sending a query packet over the network;
program code for receiving a response packet from a responding unit, the response packet including a current configuration setting;
program code for determining whether to configure the responding unit based on the response packet; and
program code for sending a configuration packet to the responding unit.

23. The software configuration utility as set forth in claim 22, wherein the response packet contains a plurality of current configuration settings of the responding unit.

24. The software configuration utility as set forth in claim 23, wherein the utility parses the configuration settings and makes a determination as to the appropriateness of the current settings.

25. The software configuration utility of claim 24, wherein the utility sends a configuration packet to units whose settings are inappropriate.

26. The software configuration utility of claim 25, wherein the units include at least one print server.

27. The software configuration utility of claim 25, wherein the units include at least one network adapter.

28. The software configuration utility of claim 25, wherein the units include at least one scanner.

29. The software configuration utility of claim 25, wherein the units include at least one printer.

30. The software configuration utility of claim 25, wherein the units include at least one all-in-one device.

31. The software configuration utility of claim 25, wherein the units include at least one fax machine.

32. A method of configuring a unit in a network, the method comprising the acts of:
receiving a query packet over the network from a configuration utility;
sending a response packet to a configuration utility in response to the query packet;
the response packet including a current configuration setting of the unit and indicating that the unit recognizes the query packet;
receiving a configuration packet over the network from a configuration utility;
parsing the configuration packet for an updated configuration setting; and
changing the current configuration setting to match the updated configuration setting included in the configuration packet.

33. The method of claim 32, wherein the configuration settings are communicated by binary data.

34. The method of claim 33, wherein the binary data is a series of delimited text strings.

35. The method of claim 33, wherein the binary data is encrypted data.

36. The method of claim 32, wherein an acknowledgment packet is sent to the configuring utility after the new configuration has been accepted.

37. The method of claim 35, wherein the configured units include at least one print server.

38. The method of claim 35, wherein the configured units include at least one network adapter.

39. The method of claim 35, wherein the configured units include at least one scanner.

40. The method of claim 35, wherein the configured units include at least one printer.

41. The method of claim 35, wherein the configured units include at least one all-in-one device.

42. The method of claim 35, wherein the configured units include at least one fax machine.
